(19) United States
(12) Patent Application Publication
(10) Pub. No.: US 2003/0005034 A1
(43) Pub. Date: Jan. 2, 2003

(54) System and method for service delivery platform in an IP centric distributed next generation network

(76) Inventor: Rajesh B. Amin, Desoto, TX (US)

Correspondence Address: RAJESH B. AMIN, 1919 PAJARITO COURT, DESOTO, TX, 75115, US

(21) Appl. No.: 09/882,433

(22) Filed: Jun. 14, 2001

(51) Int. Cl. G06F 15/16

(52) U.S. Cl. 709/202; 709/227

(57) ABSTRACT

A system and method for the proposed service delivery platform 210 to communicate with the network service provider 110, IP application service provider 170, and end-user 135 is described. The method can include a plurality of functional components of the service delivery platform 210 that communicates with plurality of functional components of the network service provider 110, IP application service provider 170, and end user 135 devices.

### FIELD OF THE INVENTION

The invention relates generally to architecture for an Internet Protocol (IP) centric distributed next generation network that supports data and telecommunication services.

### BACKGROUND OF THE INVENTION

The legacy telecommunication systems are transforming into IP Centric distributed systems. End users are increasingly using mobile devices for their communication needs. Traditional uses of fixed devices for communication such as PSTN phones are diminishing. Expectations for services desired by end users are increasing with time. Due to exceptional growth in Internet 180 technology, possibilities of service offering have increased tremendously. In wireless communication network, each mobile device has to establish local wireless link between itself and local access network 160. The local access network 160 is the part of the hierarchy of the network layers. Each network layer of the system can be owned and managed by one network service provider 110 or can be owned and managed by multiple network service providers 110.

Most services provided to the end users are from independent IP application service providers 170. Network service providers 110 are missing out on tremendous revenue opportunity. It is not feasible for Network service providers 110 to develop and integrate varieties of services for end users. Moreover, present network service providers 110 are concentrating on providing voice services to the end users. Similarly, in wireless environment, home and visited network service providers 110 are seeking to provide end user 135 services for revenue. Network service providers 110 can not design and develop hundreds and thousands of possible IP application services for their subscribed end users.

Thus, IP application services that are independently developed to provide e-commerce, e-games and many unlimited possibilities of IP applications that need to be integrated and deployed on a mass scale with the evolving next generation network by the network service providers 110.

This mandates for the network service provider 110, the development of unique mobile portal and use of complementors (others) for speedy IP application service deployment. This also mandates the development of special application servers that provide mobile portal services along with other management services.

Inspite of having functional component capabilities within the network, it is necessary for the network service provider 110 to share and/or distribute certain management capabilities to such complementors. This mandates the development of the necessary APIs through which management capabilities that control security, policy management, accounting, network management, and quality of service for services provided can be achieved.

### SUMMARY OF THE INVENTION

In contrast to the prior art as in legacy telecommunication networks that services offered to the end subscribers are tightly coupled within the network, the present invention is based on the distributed concept of the next generation network architecture. The next generation network architecture provides distributed functionality of the network in logically separated components. These components interface with each other using Internet Protocols. The present invention provides a method and apparatus for providing service delivery platform 210. The service delivery platform 210 facilitates service provisioning capabilities and service management activities that take place between network service provider 110 and associated IP application service developer or providers. This invention provides the service delivery platform 210 that facilitates network service provider 110 to distribute and share key control capabilities to associate other IP application service providers 170.

The service provisioning and service management aspects provide multiple functions (tasks) to control the services provided to the end users. Some of these functions include security 340, accounting 355, policy management 325, mobile portal control 315, configuration and provisioning 335, and resource management control 345 to name few for the provided IP application services. The security aspect provides security of the services provided to the network service provider 110's end subscriber through the associated IP application service providers 170. Accounting management activities that need to be accounted for the services provided by the IP application service providers. Policy management functions that need to be considered when providing such IP application service by the IP application service providers. Based on the IP application service requirements and to provide desired quality of service, management of associated resource control needs to be performed. Such activities are coordinated, distributed, and shared properly between the network service provider 110 and IP application service developers or providers.

The present invention provides a solution to achieve the above-mentioned tasks that provides maximum value proposition based on innovation and infrastructure. A unique innovative property of the present invention that makes ease of integrating/associating third party IP application service provider 170 with the network service provider 110. Additionally, it achieves security for use of services, accounting capabilities per user for services, policy management, and managing quality of services for the end users. A unique relationship is established within infrastructure of the network service provider 110 through the use of unique mobile portal between network service provider 110 and the IP application service developer. Independent development of protocol servers and suitable protocol interfaces that provide session invocation and session control capabilities for the above described service provisioning and service management activities established by the service delivery platform 210.

The concept and model presented for the service delivery platform 210 that comprises service provisioning and service management activities provides several advantages. These advantages include integrating and deploying IP application services rapidly in the network service provider's 110 infrastructure, ease of invoking desired services by the end users, ease of invoking desired quality of service by the end users, and most importantly, it enables network service providers 110 to offer unlimited ideas of IP application services to their end subscribers. Such IP application services can be “Interactive mobile commerce”, “Interactive games”, and “SIP based services”. In addition, convergence of telecom with many other fields such as finance, commerce, realtors, etc. will offer many other service offering opportunities.

Therefore, in accordance with the previous summary, objects, features and advantages of the present invention will become apparent to one skilled in the art from the subsequent description and the appended claims taken in conjunction with the accompanying drawings.

### BRIEF DESCRIPTION OF THE DRAWINGS

FIG. 1 illustrates Next Generation Network Architecture—Abstract View

FIG. 2 illustrates Service Delivery Platform Architecture

FIG. 3 illustrates Service Provisioning and Management Model

FIG. 4 illustrates IP application service provider providing session control configuration

### DETAILED DESCRIPTION OF THE PREFERRED EMBODIMENTS

The present invention can be described with several examples given below. It is understood, however, that the examples below are not necessarily limitations to the present invention, but are used to describe typical embodiments of operation.

The present invention can be described with several examples illustrated in figures and scenarios provided throughout this document. It is understood, however, that the examples are not necessarily limitations to the present invention, but are used to describe typical embodiments of operation. Moreover, in order to simplify discussion, certain protocols such as DIAMETER, LDAP, COPS, etc. are used as an example. In fact, the service delivery platform 210 is flexible to adopt any publicly available protocols for the similar functions. For an example, other alternative protocol for DIAMETER may include RADIUS, TACACS or it's extensions. Similarly, SIP is one Internet protocol that can have H.323 as an alternative protocol or such others that can be used for session invocation. Additionally, a list of abbreviations and glossary is listed first to facilitate a better understanding of the invention.

ABBREVIATIONS

| | |
|---|---|
| AAA | Authentication, Authorization, and Accounting |
| API | Application Protocol Interface |
| ASP | Application Service Provider |
| COPS | Common Open Protocol Service |
| CSCF | Call State Control Function |
| FCAPS | Fault, Configuration, Accounting, Performance, and Security (management) |
| IP | Internet Protocol |
| LDAP | Lightweight Directory Access Protocol |
| QoS | Quality of Service |
| SIP | Session Initiation Protocol |
| 3GPP | 3^{rd} Generation Partnership Project |

### Definition of Terms

Network service provider 110: The network service provider 110, is the network system that provides terrestrial access network 160 to the end user 135 or subscriber. The network system is distributed in hierarchical layers of network components. The layer that provides access point is the access network 160. The access network 160 can be a part of the whole network or an independent layer from the network hierarchy. The network hierarchy with network components can be own and managed by a single network service provider 110 or can be own and managed by multiple network service providers 110.

IP application service provider: An independent instance of an IP application service provider 170 provides specific IP application service to the end user. Different IP application service provider 170 may provide different IP application services. Such an IP application service provider 170 is not necessarily associated with the network service provider 110 that provides access capability to the end user. The proposed service delivery platform 210 facilitates to establish association between the IP application service provider 170 and the network service provider 110.

Next Generation Network: The next generation network is the term used to distingue new network that is more distributed functionally from the traditional tightly coupled legacy network.

IP Centric Distributed Next Generation Network: The next generation network that has distributed network components and interfaces with each other using standard TCP/IP or UDP/IP interface and communicates using application layer protocols.

End Device: An end device is the device that is attached to the network service provider 110's access network 160. In the present invention, an end-user, end subscriber, mobile users, non-wireless devices and end devices are used interchangeably often.

End user: An end user 135 is the user who receives service from the network service provider 110 or from the IP application service provider 170. In the present invention, an end-user, end subscriber, mobile users, non-wireless devices and end devices are used interchangeably often.

End subscriber: An end user 135 is the user who receives service from the network service provider 110 or from the IP application service provider 170 and is responsible for the charges incurred. In the present invention, an end-user, end subscriber, mobile users, non-wireless devices and end devices are used interchangeably often.

Components: Components are referred for network components of the network service provider 110, IP application service provider 170, the service delivery platform 210, and end-user. Network component provides specific functional procedures.

### Next Generation Network Architecture—Abstract View

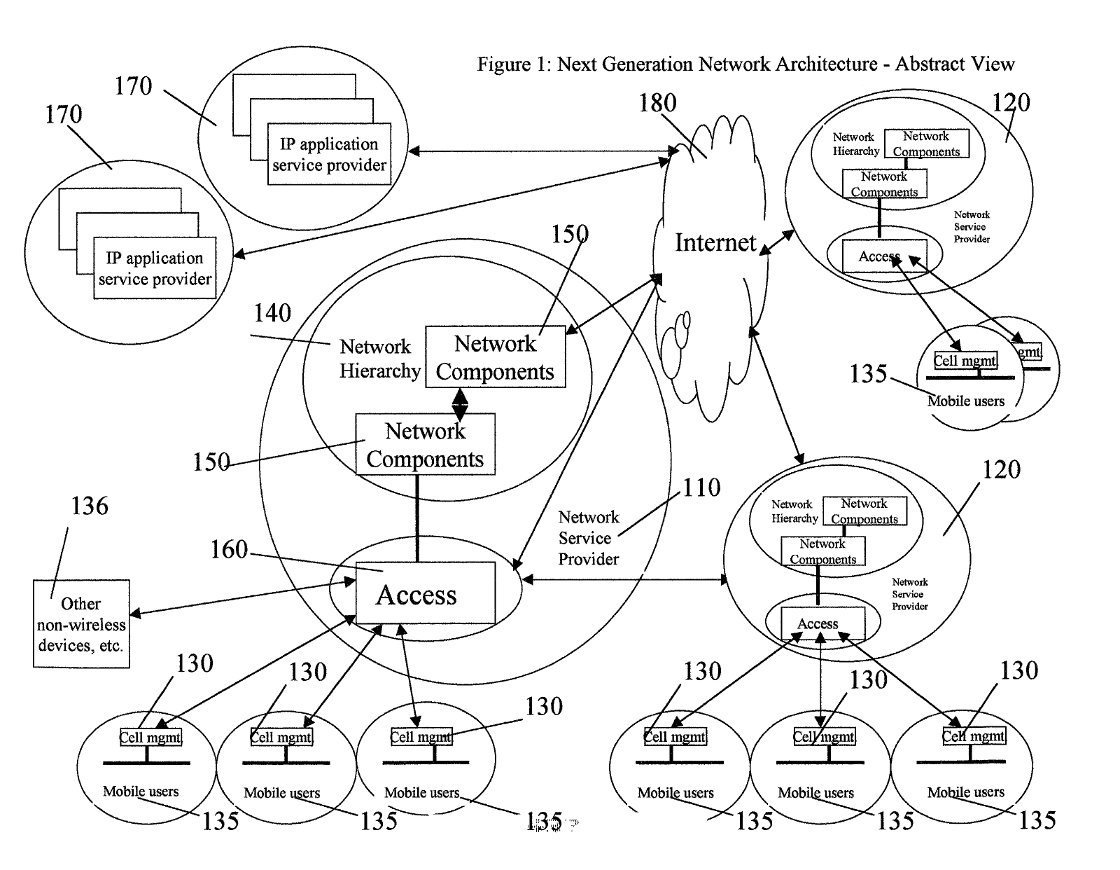

The next generation network architecture shown in FIG. 1:Next Generation Network Architecture —Abstract View represents an abstract view of the wireless network system and components. Network system consists of access network 160 and hierarchy of network components 140. Network service provider 110 controls access network 160 and hierarchy of network components 150. The network hierarchy 140 is used to distribute network tasks in different regional areas. Network components provide essential tasks to control network activities to facilitate end users' need. An access network 160 facilitates connectivity for the end users 135 with the network system. A single network service provider 110 may own and manage an access network 160 as well as hierarchy of network components 140. Or, access network 160 and hierarchical network components can be owned and managed by multiple network service providers 110.

Essential tasks of the network components 150 include session management task, handoff-related activities, policy management, accounting management, authentication, authorization, resource control management, security management, and network management. The session management task 340 facilitates network provided applications and services. The handoff-related activities facilitate continuous connectivity of mobile with the network system. The policy management task 325 facilitates and enforces network policy requirements. An accounting management task 355 facilitates billing and charge activities for the services provided and network resources used by other entities. An authentication task facilitates validation and admission of other entities to the network system. An authorization task verifies and allows use of network services and resources to other entities. The resource control management task facilitates proper provisioning of network resources. The security management task 320 facilitates to establish secured access between network systems and entities. The network management task, typically in legacy network, consists of fault, configuration, accounting, performance, and security management (FCAPS) functions. However, in the distributed next generation network architecture, some of these functions are distributed in network components. Thus, the FCAPS functions complement network management tasks that are not accommodated using other tasks mentioned.

In addition, network system consists of many other related network components that are not mentioned here for simplicity. Such network components provides task such as to facilitate IP address assignment for each device attached to the system, etc. if the mobile device is roaming, then an attached network system facilitates appropriate communication related activities with the mobile user's home network to provide appropriate service in roaming area.

The access network 160 components of the network service provider 110 provide access point to the network system for end devices and users. For wireless network, an access point of the network service provider 110 facilitates Radio/Frequency channels and necessary bandwidth for communication for mobile devices. Also, an access network 160 facilitates cell management 130 activities for handoff and hand-over activities. For non-wireless devices 136, an access network 160 is not required to facilitate cell management 130 activities described earlier.

### Need for Service Delivery Platform and Benefits

Once attachment of end user 135 is established with the network system and IP address assignment completes, then an end user 135 can reach out for any IP application services provided by any IP application service provider 170. An independent instance of an IP application service provider 170 provides specific IP application service to the end user. Different IP application service provider 170 may provide different IP application services. An IP application service provider 170 provides specific service to the end user. Thus, once access is established with the end user 135 through the network service provider 110, role of network service provider 110 becomes limited. The revenue generated from the specific service provided to the end users belongs to an IP application service provider 170.

The network service provider 110 is capable to develop and offer IP application services to the end-users as it has immediate knowledge about the end users' whereabouts and up to certain extent their profile. However, the network service provider 110 can not design and develop unlimited IP application services and offers to their subscribers. Thus, inspite of having necessary network components and mechanism in place to provide IP application services to the end users, the network service providers 110 are unable to offer such services for revenue.

In order to overcome this problem, the present invention proposes service delivery platform 210 architecture. This service delivery platform 210 architecture allows the network service providers 110 to integrate third party developed IP application services in their network and provide capability to offer unlimited IP application services to their subscribers. The proposed service delivery platform 210 provides service provisioning and service management capabilities.

The service delivery platform 210 offloads critical responsibilities from the network service provider 110 that facilitates IP application services to the end users. The distribution of essential tasks that facilitate IP application services to the end users from the network service provider 110 to the service delivery platform 210 alleviates responsibility of developing individual IP application services within network service provider 110's network. It helps to deploy IP application services rapidly in network service provider's 110 infrastructure. Additional benefits include ease of invoking desired services and ease of invoking desired quality of service. It also enables network service providers 110 to offer unlimited ideas of IP application services. To name few of them include interactive mobile commerce, interactive games, and Session Initiation Protocol based services. Many more services derived from convergence of telecom with many other fields such as finance, commerce, realtors, entertainment, etc.

With such distribution, the network service provider 110 assumes high-level aggregation responsibilities for the IP application services provided to their subscribers/users. Such capability will increase revenue potential for the network service provider 110 tremendously. This will simplify network system operations and take advantage of offering newly ongoing developed IP application services by the third party vendors.

### Service Delivery Platform Architecture and Model

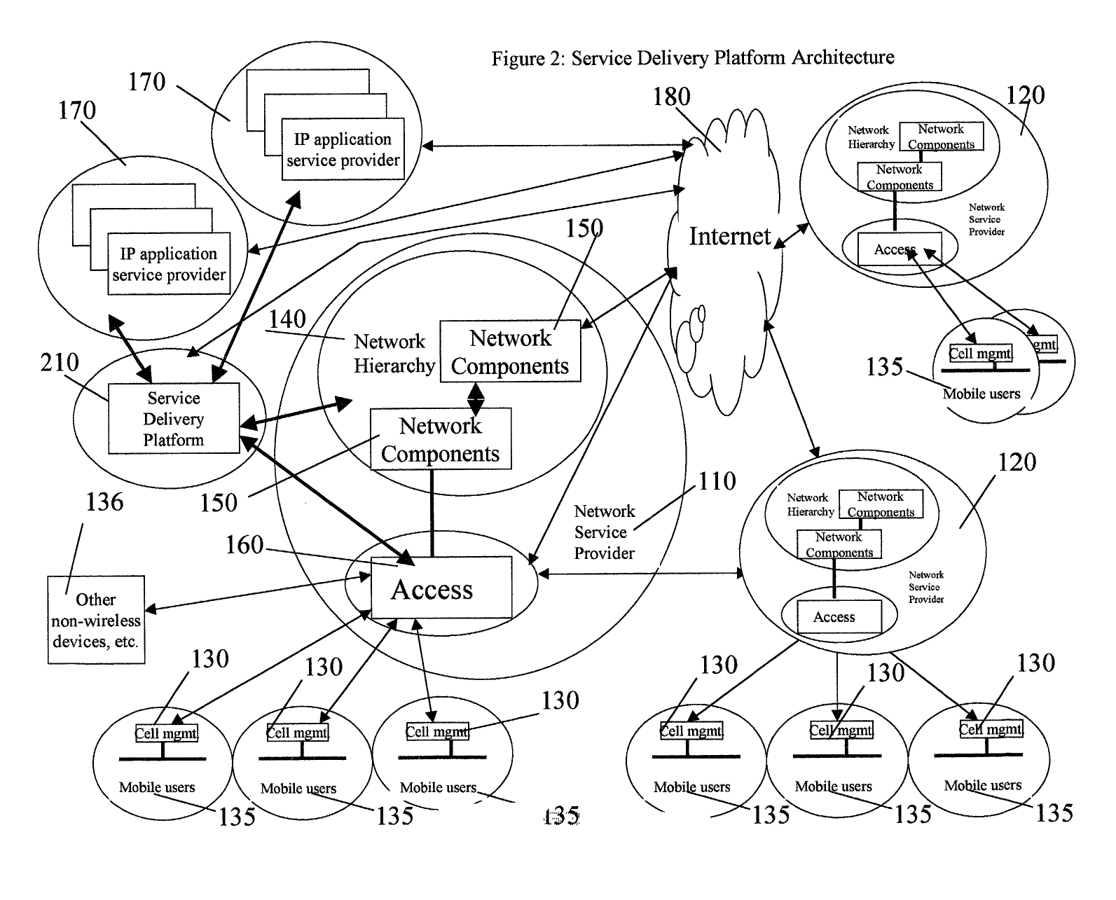

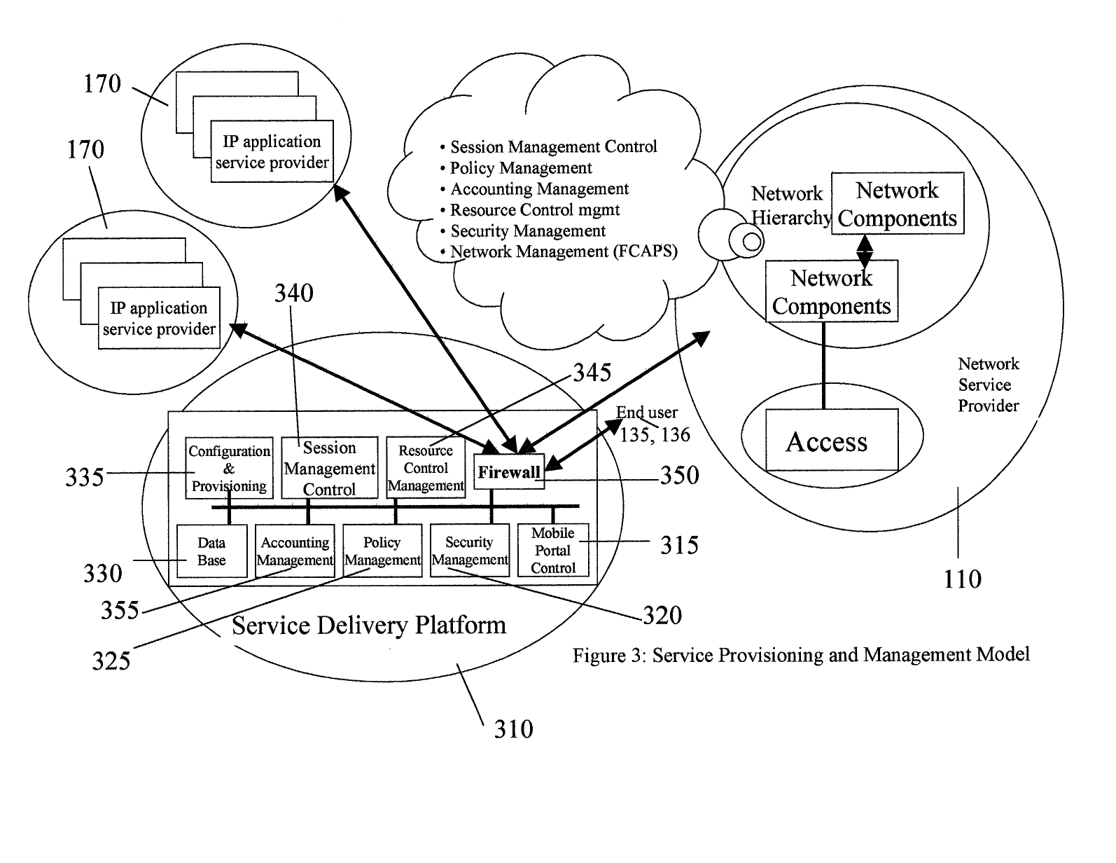

As shown in FIG. 2: Service Delivery Platform Architecture, a service delivery platform 210 is introduced as a system component. This platform interfaces with the network service provider 110's network components and access network 160 components, IP application service provider's components 170 and end user 135. An interface with an access network 160 is limited in scope to the extent that is pre-defined by the network service provider 110 domain. As shown in the FIG. 3: Service Provisioning and Management Model, the service delivery platform 210 consists of many tasks that have counterpart in the network service provider 110. The essential tasks of the service delivery platform 210 include session management control, policy management, accounting management, resource control management, security management, mobile portal control 315, network management that include configuration and provisioning management 335, and pertinent data base 330 component. The proposed service delivery platform 210 provides IP application service provider 170 provisioning and service management capabilities. The service delivery platform 210 facilitates service management activities between network service provider 110, end users, and IP application service provider 170. The service delivery platform 210 facilitates IP application service provider 170 provisioning, required enabling end user 135 service activation procedures, and required interaction activities between end users & IP application service providers 170, service delivery platform 210 & end users 135, service delivery platform 210 & network service provider 110 etc.

Each task of the service delivery platform 210 communicates using appropriate Internet protocol, internally with the service delivery platform's components and externally to the network service provider 110's network components and access network 160 as well as IP application service provider's components and finally to the end users. It uses firewall 350 for security for first line of defense to achieve secured accesses. For an example, policy management task 325 between the service delivery platform 210 and the network service provider 110's network component is done using standard COPS protocol. It is possible to support multiple well-known standard protocols defined for specific tasks.

In the proposed model, the network service provider 110 assumes responsibility of provisioning subscribers and their desired services. The service delivery platform 210 assumes responsibility of provisioning IP application service providers 170. In doing so, the service delivery platform 210 follows network service provider 110's guidelines in provisioning IP application service provider 170. Also, the service delivery platform 210 keeps necessary records related to IP application service providers 170, in local database. It is also possible to keep such records at the central database of the network service provider 110 and update it at predefined interval. Once subscribers at the network service provider 110 and IP application service provider 170 at the service delivery platform 210 are provisioned, the service delivery platform 210 manages delivery of IP application services to the end users. The service delivery platform's counter parts at the network service provider 110 manages aggregation of final results rather than managing specific details that is specific to the IP application services provided to the end users. The service delivery platform 210 architecture is scaleable and allows the network service provider 110, the ability to expand specific service delivery tasks independently of other tasks. Also, the service delivery platform 210 is capable to plug and play with the network service provider 110's infrastructure.

Upon attachment to the network service provider 110 by the end user, the network service provider 110 downloads end user's profile, policy requirements, subscribed services, along with necessary management data (e.g. accounting method, etc.) to the service delivery platform 210. The service delivery platform's tasks verifies availability of the subscribed services at the IP application service provider 170, sets ups security aspect for the end user 135 to access IP application service provider 170. The service delivery platform's mobile portal control 315 task pushes necessary applets and service invocation capabilities to the end device. Upon service invocation by the end user, request goes to appropriate IP application service provider 170. An IP application service provider 170 validates the end user 135 using security mechanism facilitated by the service delivery platform 210 that was setup earlier by the security management task 320. In case of IP application service invocation request and/or any parameter dispute, the IP application service provider 170 interface with the service delivery platform 210 for resolution. The service delivery platform 210 resolves issues using subscriber's profile, policy requirements, accounting methods used, and any other pertinent details. If invocation request demands setup of additional resources, the service delivery platform 210 based on subscriber's data and guidelines provided by the network system, facilitates additional resources directly to the access network 160 within limited permission granted or facilitates through the network components. Upon completion of IP application service, the service delivery platform 210 collects appropriate accounting data from the IP application service provider 170 and reports it to the network service provider 110 for aggregate billing and charging to the subscriber. The service delivery platform 210 may use other techniques to collect usage data. For an example, the service delivery platform 210 requests to the end user 135 or a client running at the end device that collects usage data.

### Scenarios of Operations

Provisioning and maintenance activities summarize the operations that take place at the service delivery platform 210. As discussed in the service delivery platform 210 architecture and model earlier, the subscriber's provisioning takes place at the network service provider 110. The subscribers' pertinent records are located at the central database at the network system of the network service provider 110. As long as the subscribers/end users are using default services of the network service provider 110 such as simple access through the network, the interactions with the service delivery platform 210 does not take place. When the subscribers/end users subscribe to the special services that can be provided through the provisioned IP application service provider 170, the involvement of the service delivery platform 210 takes place.

The IP application service provider's provisioning activities take place through the service delivery platform 210. The majority of the service delivery management activities are taking place at the service delivery platform 210. The service delivery platform 210 assumes majority of service management activities and provides final aggregate results to the network service provider 110.

The following scenarios are identified:

1. New IP application service provider 170 associate with the network service provider 110

The service delivery platform 210 interfaces with the new IP application service provider's components to exchange necessary information such as IP addresses and port numbers of the involved components and establishes an access agreement. The configuration and provisioning task 335 interfaces with the policy management task 325 for the pertinent network policy and guidelines provided by the network service provider 110. The IP application service provider's pertinent information is kept at the database managed by the service delivery platform 210. The network service provider 110 accesses such data from the service delivery platform 210 when needed in order to offer such IP application services to the new subscribers and provisioning them with the network system.

2. New subscriber 135 signs up (provisions) for the IP application service offered by the network service provider 110

The network service provider 110 uses IP application service provider's related services and pertinent data such as IP addresses, port number, type of service, billing method, mutually agreed policy between IP application service provider 170 and the network service provider 110, etc., from the service delivery platform's database. Once service is offered and accepted by the end subscriber, the subscriber's profile is updated at the central database at the network service provider 110. The service delivery platform 210 and IP application service provider 170 may be informed at this time to flag for potential IP application service user. However, it is not necessary at this time.

3. Subscriber/end user 135 becomes active (establishes attachment with the network system)

Upon establishing attachment with the network system, the network system performs all typical operations such as to register subscriber/end user, fetching subscriber's profile from the local network system or from the home network system 120, IP address assignment, authentication and authorization tasks, as well as necessary default accounting methods, etc.

Once above-mentioned procedures are performed, the network system fetches necessary subscriber's profile that reflects subscribed IP application services, accounting methods to use, and relevant network and subscriber's policy information.

This information is passed to the appropriate component of the service delivery platform 210. The session management task 340 of the service delivery platform 210 executes necessary steps by coordinating with the security management task 320, policy management task 325, and mobile portal control 315 task of the service delivery platform 210. These steps include making sure of availability of the IP application services from the IP application service provider 170, setting up the security mechanism between the end user 135 and the IP application service provider 170, meeting pre-defined policy requirements, enabling mobile device with the service invoking capabilities based on the type of mobile device used, etc.

4. An end user 135 invokes an IP application service

When an end user 135 invokes any particular service, an invocation request goes to the appropriate IP application service provider 170. By this time, the IP application service provider 170 is configured by the service delivery platform 210 tasks with the appropriate security mechanism to apply and end user's capability to use network system's resources.

There are two scenarios an IP application service provider 170 may face:

a) Normal operation

In this scenario, an end user 135 sends request to the IP application service provider 170. The IP application service provider 170 matches all requested parameters and determines that it can fulfill all service requirements without changing resources allocated to the end user 135 and the service scope is within the limit and guidelines provided by the service delivery platform 210. In this case, the IP application service provider 170 renders IP application service. Based on the accounting policy for the service, complete usage record is transferred once to the service delivery platform 210 or interim record at pre-defined interval to the service delivery platform 210. Alternatively, if chosen, the service delivery platform 210 collects usage data from the client collecting data at the end user. Based on the policy, the service delivery platform 210 transfers service usage data to the network service provider 110 for aggregation.

b) Special condition operation

In this scenario, an end user 135 sends request to the IP application service provider 170. The IP application service provider 170 matches all requested parameters and determines that it can not fulfill all service requirements without changing resources allocated to the end user 135 and service scope is not within the limit and guidelines provided by the service delivery platform 210. In this case, the IP application service provider 170 interacts with the service delivery platform 210 to facilitate appropriate network resources. The service delivery platform 210 performs necessary steps to facilitate end user's need based on the policy and guidelines provided from the network service provider 110 for that particular subscriber. The session management task 340 controls the execution in coordination with the policy management task 325 and resource control management task. The service delivery platform 210 interfaces with the network system in order to accommodate or change in provided network resources. The service delivery platform 210 interfaces with the access network 160 components if direct access is provisioned by the network system, else the service delivery platform 210 interfaces with the network components of the network service provider 110.

Upon resolution with the service delivery platform 210, the IP application service provider 170 renders IP application service. Based on the accounting policy for the service, complete usage record is transferred once to the service delivery platform 210 or interim record at pre-defined interval to the service delivery platform 210. Alternatively, if chosen, the service delivery platform 210 collects usage data from the client collecting data at the end user. Based on the policy, the service delivery platform 210 transfers service usage data to the network service provider 110 for aggregation.

### Service Management Functions

The service delivery platform 210 has the following important functions that facilitate service provider's provisioning and service management functions:

### Security Management 320

The security management task 320 provides mechanisms such that only subscribed end users can access IP application services provided from the provisioned IP application service providers 170. One of the techniques that can be used as defined in kerberos. In that case, the key distribution center and ticket granting service responsibility is at the service delivery platform 210. Different techniques can be incorporated to secure the use of service.

### Accounting Management 355

The accounting management task 355 collects usage data from the IP application service provider 170 for each service provided to the end users. Also, it is possible to collect network usage data from the access network 160 of the network service provider 110 up to certain extent if the access to access network 160 is granted by the network service provider 110. Also, it is possible that the service delivery platform 210 collects usage data from the end user 135 or an appropriate application running at the end device. In any case, the accounting management task 355 reports data to the network service provider 110 for the final aggregation for billing and charges purpose. The accounting method to be used for a specific subscriber is provided to the service delivery platform 210 at the time of end device's attachment to the network service provider I 10. The service delivery platform 210 has the capability to start an accounting client to collect usage data at the access network 160, at the end device, or at the IP application service provider 170. It has capability to report whole data usage record at one time or to report data usage in pre-defined time interval or upon certain amount of data collection. The most efficient and simplest way to data collection and reporting is based on start time, end time, and specific bandwidth and quality of service provided for that period. If the quality of service and/or bandwidth parameters are changed and appropriate resources are facilitated for service requested during the active session, then multiple start time and end time with specific QoS and bandwidth need to be reported. The service delivery platform 210 can use any well-known standard protocols for the accounting management interfaces. Such protocols include RADIUS, DIAMETER, etc.

### Policy Management 325

The policy management task 325 of the service delivery platform 210 provides policy decision function to the IP application service provider 170 and also to the end devices while it provides policy enforcement function for the rules set by the network service provider 110. The network service provider 110 provides various rules for the IP application service providers, end users' capabilities, service restrictions (e.g. expected quality of service, time of day, etc.), and many other operating aspects for the service delivery platform 210 to follow and enforce. The policy management can use well-defined standard protocol to communicate with different entity. Such protocols include COPS, SNMPv3, etc.

### Resource control management 345

The resource control management task 345 facilitates resource control activities that may require change in network resources due to service invocation. Based on permission granted from the network service provider 110 to the service delivery platform 210, it accesses network resources to facilitate service demand. Again, of course with the policy constrained. The resource control management task 345 facilitates quality of service control at the access network 160. The service delivery platform 210 provides quality of service broker functionality and manages in coordination with the network system. The resource control management 345 can use well-defined standard protocol to communicate with different entity.

### Session Management Control 340

During service invocation and termination, the service delivery platform 210 monitors and manages appropriate service execution. The session management task 340 in coordination with other tasks within the service delivery platform 210 executes sequence of actions. Such sequence of actions enables the service delivery platform 210 to perform key functions. Some of these functions include enforcement of network service provider 110's policy requirements, service interactions with the IP application service provider 170, interactions with network service provider 110, enabling & providing service invocation capability to the end user, setting up secured mechanism for the end users to access IP application services and other communication links, etc. The service delivery platform 210 can interact with an IP application service provider 170 to render service to the end user. The network service provider 110 can trigger such invocation of service to the end user.

### Mobile Portal Control 315

The network service provider 110 informs the service delivery platform 210 about an activation of end user 135 to the network system and provides end user's information with respect to the subscribed services and network system's policy information to the service delivery platform 210. The service delivery platform 210 performs necessary sequence of operations and coordinate with the mobile portal control task 315. The mobile portal task facilitates end user 135 that provides invocation capability to the end user 135 based on the type of device used. This enables end user 135 to invoke desired service.

### Configuration & Provisioning Management 335

During IP application service provider 170 provisioning, accesses between components of the service delivery platform 210 and IP application service provider 170 are configured. The plug and play capability is achieved using configuration management 335 task that allows easy installation and configuration of other tasks with the IP application service provider 170 and the network service provider 110. This capability brings many advantages to the network service provider 110 and the IP application service provider 170 such as easy installation, easy realization of scalability, etc.

### An Example of an IP Application Service

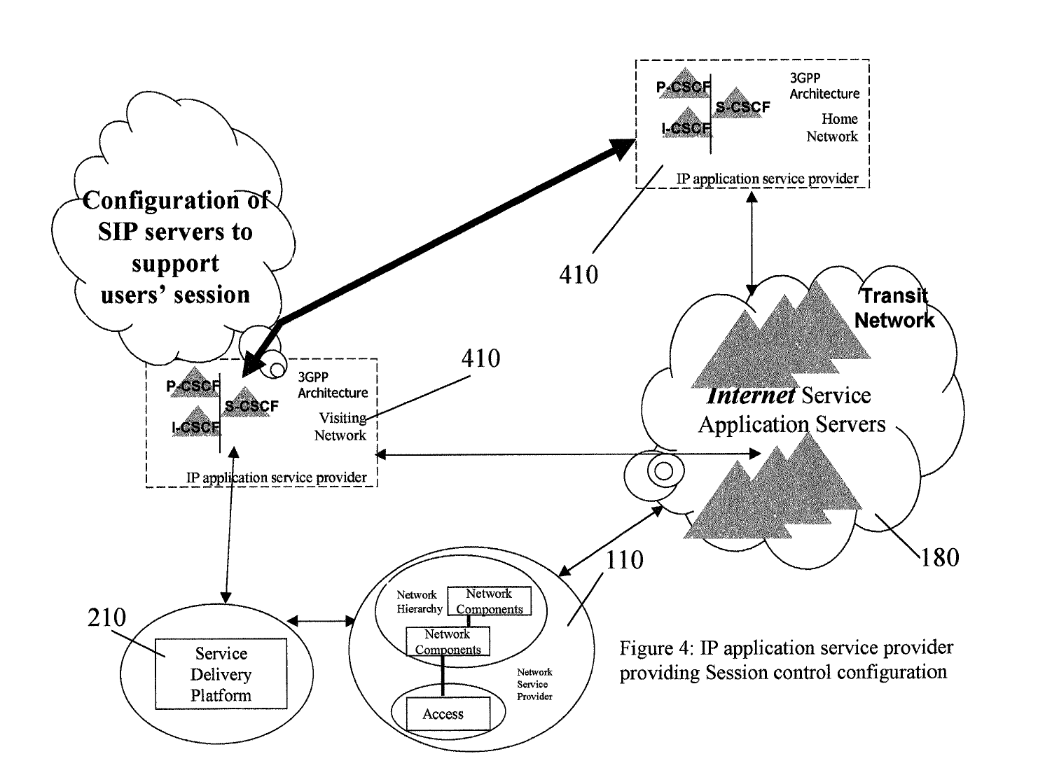

The FIG. 4: IP application service provider providing session control configuration shows an example of an IP application service provider 170 takes the role as IP application service provider 410 providing session control configuration as defined in 3GPP for next generation network architecture. The IP application service is using CSCFs's configuration in visiting network 410 and home network 410 environment to provide session control capabilities for multimedia (voice, data, and video) application as defined in standard. In order to design and develop such service by the network service provider 110 and integrate within the network service provider 110's domain results in increased complexity and transforms distributed network back to the tightly coupled network. Imagine how much complexity would increase with additional support of another session management protocol such as H.323? Thus, as shown in FIG. 4: IP application service provider providing session control configuration, any number of protocols support can be added in the network service provider 110's infrastructure (domain) by integrating and deploying capabilities developed by an independent IP application service provider 170. Such integration and deployment capabilities can be achieved and easily facilitated by the proposed service delivery platform 210.

Other examples include integration of entertainment, finance, e-commerce, m-commerce, multimedia services, and many unlimited ideas of IP application services developed in future.

It is understood that several modifications, changes and substitutions are intended in the foregoing disclosure and in some instances some features of the invention will be employed without a corresponding use of other features. Accordingly, it is appropriate that the appended claims be construed broadly and in a manner consistent with the scope of the invention.

1. A method for a service delivery platform to provision and configure third party IP application service provider for the network service provider to deliver Internet related services in an Internet Protocol (IP) centric distributed network to a first user, the method comprising:
establishing policy requirements set by the network service provider with third party application service provider;
establishing configuration between functional components for access;
maintaining third party IP application service provider's records;
managing delivery of IP application services;
reporting service related information and accounting records for a first user to network service provider.

2. The method of claim 1 further including providing session management control, policy management, accounting management, resource control management, security management, mobile portal control, and network management that include configuration and provisioning management by the service delivery platform.

3. The method of claim 1 further including providing service management capabilities by the service delivery platform.

4. The method of claim 1 further including facilitating service management activities between the third party IP application service provider, network service provider and the first user by the service delivery platform.

5. The method of claim 1 further including facilitating enabling of service activation for the first user, and interaction activities between the first user, the service delivery platform and the third party service provider.

6. The method of claim 1 further including interfacing with the service delivery platform for resolution in case of third party IP application service provider invocation and any parameter dispute.

7. The method for a network service provider to interface with the service delivery platform to configure third party IP application service provider to deliver Internet related services in an Internet Protocol (IP) centric distributed network to a first user, the method comprising:
conveying first user's authorized services and user's profile;
accounting method to use for final usage data reporting of a first user;
conveying network policy requirement for a specific to Internet related service for a first user.

8. The method of claim 7 further including facilitating end user's access to a third party IP application service provider.

9. The method of claim 7 further including facilitating a third party IP application service provider by service delivery platform to enable to provide IP application service to a first user.

10. The method of claim 9 further including facilitating security mechanism between a third party IP application service provider and a first user.

11. A system for a service delivery platform to manage invoked IP application services by a first user to a third party IP application service provider, the system comprising:
a first user requests a IP application service to a third party IP application service provider;
a third party IP application service provider renders a service to a first user;
a third party reports accounting usage to a service delivery platform;
a service delivery platform facilitates network resource needs for a first user.

12. The method of claim 11 further including facilitating network's resources needed in providing IP application service to a first user.

13. The method of claim 11 further including facilitating accounting clients at a first user to collect usage data.

14. The method of claim 11 further facilitating policy requirements to accommodate resources.

15. The method of claim 11 further performing sequence of actions within a service delivery platform to coordinate network service provider's guidelines.

16. The method of claim 11 further stores accounting usage at a local data base.

17. The method of claim 11 collects complete accounting usage from a third party IP application service provider.

18. The method of claim 11 collects interim accounting usage data and stores in a local data base.

19. The method of claim 11 reports collected accounting usage data of a first user to a network service provider for final aggregation, billing and charges to a first user.
